(19) United States
(12) Patent Application Publication
(10) Pub. No.: US 2005/0226421 A1
(43) Pub. Date: Oct. 13, 2005

(54) Method and system for using watermarks in communication systems

(75) Inventors: Alain Charles Louis Briancon, Poolesville, MD (US); Akinlolu Oloruntosi Kumoluyi, Plainfield, NJ (US); Alan Gerald Carlton, Mineola, NY (US); Richard Dan Herschaft, Whitestone, NY (US); John Erich Hoffmann, Indialantic, FL (US); Prabhakar R. Chitrapu, Blue Bell, PA (US); Debashish Purkayastha, Pottstown, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/060,840

(22) Filed: Feb. 18, 2005

Related U.S. Application Data
(60) Provisional application No. 60/545,678, filed on Feb. 18, 2004.

(51) Int. Cl. H04K 1/00

(52) U.S. Cl. 380/270

(57) ABSTRACT

A method and system for using watermarks in communication systems is disclosed. Watermarks are typically small amounts of auxiliary data embedded in a cover signal. The cover signal is the primary communication signal, and may be binary bits, multi valued symbols, analog waveforms, or any other type of primary communication signal. Security strength indication, location tracking, intrusion detection and transmission of non-security information using watermarks are disclosed, along with a system for managing watermarks.

### CROSS REFERENCE TO RELATED APPLICATION(S)

This application claims the benefit of U.S. Provisional application No. 60/545,678, filed Feb. 18, 2004, which is incorporated by reference as if fully set forth.

### FIELD OF INVENTION

The present invention relates generally to communication systems. More specifically, the present invention is directed to using watermarks in communication systems.

### BACKGROUND

Communication systems provide a large and growing number of convenient communication services, and have become a pervasive part of modern life. Such communications will continue to grow in popularity and capability, driven by such innovations as the availability of high-speed wired and wireless Internet access, rapidly developing wireless devices, growing popularity of global positioning system (GPS) applications, etc. As the use of these technologies continues to grow, however, currently apparent deficiencies and susceptibilities are likely to become more troublesome, while others are likely to arise. For example, valuable consumer data can readily be extracted from many sources where the consumers have little or no control over the extraction of data which they may have voluntarily provided to a third party for a legitimate purpose. With no control mechanisms, such extraction of consumer data may cause users to view their communications as risky and feel as though the risks are invisible and/or impossible to control.

The issues outlined above may generally be categorized as pertaining to “trust,” “rights,” “identity,” “privacy” and “security,” collectively referred to as TRIPS. “Trust” refers to the assurance that the entity to which information being communicated in these systems is dependable in specific situations. To illustrate, a user may want to know that a communication was sent to it from a trusted source, using trusted communication nodes. The user in an ad-hoc network may have no knowledge that the communication was transferred over a hacker's device with packet sniffing software. Additionally, with the use of tunneling, intermediate nodes transferring the communication may be transparent to the user.

“Rights” (or “rights management”) refers to the control of access to data or devices. To illustrate, a user may have limited rights in a communication system, and is therefore restricted to a subset of available services while operating within the system. However, if that user colludes (knowingly or unknowingly) with a second node having superior rights, that user may gain rights above those that the user is allowed, and thereby gain access to system resources not otherwise available to him.

“Identity” refers to the control of information associated with the identity of a user. To illustrate, a rogue device may attempt to access a network by pretending to be an authorized user of the network, by using that authorized user's identity.

“Privacy” refers to ensuring the privacy of the individual, the data and the context. To illustrate, a user may not want others to know which web sites the user visits. Or, a user may want to keep specific communicated information private, such as financial or medical information, etc.

“Security” refers to the security of the data and context, such as preventing an unauthorized individual access to a user's information.

To reduce the susceptibility of communication systems to unauthorized or unintended access to data residing or being communicated on them, techniques such as wired equivalent privacy (WEP), Wi-Fi Protected Access (WPA), Extensible Authentication Protocol (EAP) and GSM based encryption are used. Although these techniques provide some protection, they are still susceptible to trust, rights, identity, privacy and security issues. To illustrate, although a particular wireless communication node may have the correct WEP keys to communicate with a wireless user, that user may not know whether he/she can “trust” that node.

Additionally, authentication of the user using the keys required by these systems typically occurs at higher layers of the communication stack. Accordingly, even when these controls are in place, a rogue wireless user or hacker may have some (although limited) access to the communication stack. This access creates vulnerabilities, such as to denial of service attacks, among others.

A Watermark (or digital watermark) is typically a small amount of auxiliary data that is embedded in a cover signal, which is the primary communication signal. The cover signal may be binary bits or multi valued symbols or analog waveforms involved in the primary communication. Since the watermark is embedded in the primary communication signal, it is desirable to explore how watermarks may be used to protect communication systems, in all aspects described above.

### SUMMARY

The present invention is a method and system for using watermarks in communication systems. Watermarks are typically small amounts of auxiliary data embedded in a cover signal. The cover signal is the primary communication signal, and may be binary bits, multi valued symbols, analog waveforms, or any other type of primary communication signal. Security strength indication, location tracking, intrusion detection and transmission of non-security information using watermarks are disclosed, along with a system for managing watermarks.

### BRIEF DESCRIPTION OF THE DRAWINGS

FIG. 1 is a wireless communication system wherein WTRUs are provided with a security strength indicator providing an indication of the level of protection provided within the coverage area in which the WTRU is operating.

FIG. 2A is a WTRU having a screen wherein a security strength indicator is displayed.

FIGS. 2B and 2C are graphical representations of a security strength indicator.

FIG. 3 is a coverage area of a base station of a wireless communication system in accordance with the present invention.

FIG. 4 is a WTRU and base station configured for managing the use of watermarks.

FIG. 5 is a wireless communication system wherein watermarks and sensors are used for intrusion detection in accordance with the present invention.

### DETAILED DESCRIPTION OF THE PREFERRED EMBODIMENTS

As used herein, a wireless transmit/receive unit (WTRU) includes but is not limited to a user equipment, mobile station, fixed or mobile subscriber unit, pager, station (STA) or any other type of device capable of operating in a wireless environment.

As used herein, a base station (BS) includes but is not limited to a Node-B, site controller, access point or any other type of interfacing device in a wireless environment. When referred to hereinafter a transmit/receive unit (TRU) includes a WTRU, base station or a wired communication device.

As used herein, watermarks include but are not limited to metadata, tokens, keys, signatures, or any other type of identifying information associated with data packets. The information may be derived directly from TRU specific information, or from or in conjunction with other information.

The features of the present invention may be incorporated into an integrated circuit (IC) or be configured in a circuit comprising a multitude of interconnecting components.

### Watermarking of Communications

As used herein, watermarking can be broadly classified into two main categories; 1) watermarking of messages for security purposes, to thwart improper use of network resources or information; and 2) watermarking of messages for non-security purposes, such as to indicate context information, or to provide more efficient signaling or better control.

With regard to security purposes, the different means of generating watermarks can be classified based on their security levels, complexity and cost of implementation. Depending on security needs, any of various levels of security can be implemented. In general, the security of a communications system can be multi-tiered, and the security parameters of higher network layers can be set using watermarks.

The choice of stack for communication is preferably based on the physical level security (i.e. layers 1-7). The type of security at the different levels is varying based on the physical level. In one embodiment, networks may be deployed using physical security the way in which frequency, time slot, and code are used.

The steps to address security issues can be generally categorized as follows: prepare for attempts to improperly use network resources or information; prevent such use (secure against and deter such use); detect; alert; contain and eliminate such use; and identify the improper user.

Preparing for improper use relates to putting mechanisms in place to manage heightened potential risk of improper use. Similar to the profiling of individuals known or believed to have engaged in unsafe activities, and assessing and containing the potential risk of such individuals to airline travelers. A similar database for communication offenders can be established and managed. Watermarks can be used to identify offenders, and to indicate their appearance on the network; whereupon precautionary measures can be taken, such as increasing the network security level.

Preventing improper use relates to securing a network against improper use, and deterring such use. With respect to securing a network, when the existence of a security risk on the network is detected, a security state can be broadcast to the network, similar to a terrorism threat level (red, orange, yellow), for example. The security state can be communicated by an AP or base station, which can initiate a change, up or down, in the amount of security enabled by the network and/or client devices.

With respect to deterring improper use, indicators of security measures in place may be employed, for example. This is analogous to indicating the existence of a building security system against unauthorized entry by displaying a sign that such a security system is in use. The indicator can be controlled by watermarks, and can include the display of a logo or other indicator defining the currently applied security standard. Other protection indicators can include those associated with measures that a user can enable or disable.

Another method to deter improper use of network resources and information is to provide an agent that periodically checks in on each user to see if everything looks normal. In this case, the average user is monitored to make sure all activity that affects him is conventional.

Detection of improper use may be accomplished by implementation of an intrusion detection protocol, for example. Out of character behavior for individual network users can be detected and used to heighten security measures. For example, it can be determined through monitoring that a user normally uses network resources or information in some sort of a repeatable pattern or profile. If the user changes behavior in some significant and possibly risky way, this detection can enable additional security precautions, or trigger an authentication or re-authorization procedure.

Another method to detect improper use is to place sensors on the network at various locations to continuously monitor user activity. Any transmissions without the proper watermarks, can trigger an intruder alert. This can be used to re-authenticate the users in the vicinity of the detecting sensor. The security level of the network can also be upgraded, and sensors may also be used to identify the location of the intruder.

Another method to detect improper use of network resources and information is to provide an agent that sends a check-up to a user who appears to be engaging in uncharacteristic and/or risky activities. Such activity can either be detected at the AP (e.g., MAC address re-use); or detected through a “neighborhood watch” program where clients in the vicinity detect improper behavior.

User monitoring can be accomplished in an office building or campus employing sensors in each room or at many locations. The RF range of the sensors can be limited, e.g., by transmitting at low power. The user equipment can be asked to relay beacons transmitted by the sensors, and the network can thereby track the user continuously.

With respect to providing an alert to improper use, a security indicator on a device attached to a network, similar to a battery power level indicator, can be provided to indicate the type of activity the device is engaged in.

With respect to containing improper use, e.g., by use of watermarks for repudiation, when a rogue transmitter is identified on a network, its identity can be broadcast to the other network users, and all devices can be directed to ignore the rogue transmitter's requests for the medium. In 802.11, this can be accomplished by ignoring any virtual carrier sense reports from the transmitter. This is less complicated than ignoring the physical carrier sense, since in that case the determination of the source is made at a higher layer. A broadcast of the currently identified threat can also indicate which network mechanisms should be protected better.

With respect to eliminating improper use, in the event of a denial of service attack, all network devices can be instructed to begin packet-by-packet inspection for a specific TA in the packet header of 802.11 wherein detected packets can be ignored.

To identify an improper user, watermarks can be used to indicate information about a user or device improperly using network resources or information. Watermarks can indicate, for example, context information such as physical or logical location, or device specific information such as a hardware identifier. Additional detail regarding the use of watermarking for security purposes is provided in the description of the Figures, which is hereinbelow.

Referring now to using watermarks for non-security purposes, watermarks may be used for all types of non-security purposes including, for example, context, signaling, and control. A few examples are provided below.

Comparison of a watermark between two and more devices can be used to determine the distance (physical and logical) between devices and used for a multitude of uses (location, intrusion detection, context awareness, routing, store and forwarding, power management, etc. . . . ). Header overhead can be reduced by using watermarks instead of MAC or IP information in a header. This can be useful where the capabilities of the network or of networked devices are limited, and it is critical to reduce the size of data packets or to conserve bandwidth.

Watermarks can also be used to implement providing and accounting for different service levels to users in different service classes. For example, a user may want to ensure security or other special protections when less than desirable conditions exist in the network. Watermarking can be enabled as a function of a service plan. For example, in a CDMA system extra physical layer protections can be maintained on traffic only of a specific user class, invisible to the user. Only traffic of that class can run on those protected lanes of digital communication.

Watermarks can also be used in an ad hoc fashion in social gatherings, to match likes and dislikes of people in the same vicinity. They can also be used as news broadcasters in an ad hoc fashion to distribute context information such as accident data, temperature data, etc. Additional detail regarding the use of watermarks for non-security purposes is provided in the description of the Figures, which is hereinbelow.

### Security Strength Indication by Watermarks

In a first embodiment of the present invention, a security strength indicator is provided to devices operating within a communication system. There are many different techniques for addressing TRIPS issues in communication systems. For example, specific techniques for addressing various TRIPS issues are described in U.S. patent application Ser. No. 10/996,493, filed on Nov. 23, 2004 (hereinafter the '493 application), 11/035,174, filed on Jan. 13, 2005 (hereinafter the '174 application), and 11/034,987, filed on Jan. 13, 2005 (hereinafter the '987 application), each of which are incorporated by reference as if fully set forth herein. The various watermarking techniques may generally be classified based on the level of protection provided, complexity, and cost of implementation. The security strength indicator described herein quantifies the level of protection provided on a per base station basis based on the techniques being implemented by the particular base station and provides an indication to the WTRUs operating within the base station's coverage area of the level of protection provided in that coverage area.

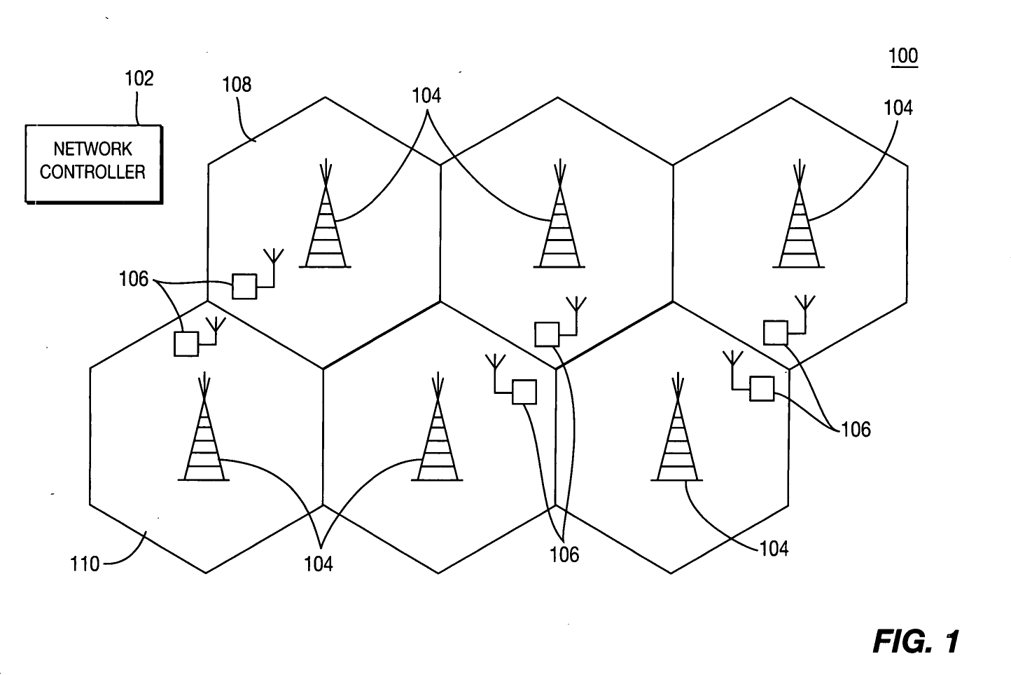

Referring now to FIG. 1, a wireless communication system 100 is shown. The wireless communication system 100 includes, in one embodiment of the present invention, a network controller 102, a plurality of base stations 104, and a plurality of WTRUs 106. In a preferred embodiment of the invention, a security strength indicator is provided to or by each base station 104 in a wireless communication system 100. The base station 104 communicates the security strength indicator to the WTRU's 106 operating within its coverage area.

The security strength indicator is preferably generated on a per base station basis. This allows, for example, a particular security strength indicator to be provided for the WTRUs 106 operating within coverage area 108 while WTRUs 106 operating within coverage area 110 are provided with a different security strength indicator. This is useful in situations where coverage area 108 is, for example, a residential area wherein lower tier protection techniques are implemented and coverage area 110 is, for example, a military base wherein higher tier protection techniques are implemented. The security strength indicators may be broadcast from the base stations 104 to their respective WTRUs 106. Alternatively, the security strength indicators may be transmitted as watermarks from the base stations 104 to their respective WTRUs 106.

The security strength indicators may be generated at a network controller 102 for each of the base stations 104. In another embodiment, the base stations 104 may generate their own security strength indicators. In still another embodiment, the WTRUs may be configured to generate security strength indicators where they are operating in an ad-hoc network, for example. Or, the security strength indicator may be generated by the base stations 104 based on information reported to them by the WTRUs 106.

The security strength indicator is preferably generated dynamically in that it may be computed at predetermined intervals. In this manner, the security strength indicator may vary as a function of the state of the system 100. For example, if an intruder is detected in say coverage area 108, the security strength indicator may be upgraded or otherwise adjusted, as appropriate.

The security strength indicator may be quantified as desired. For example, a coverage area in which 128 bit encryption is being used may have a higher security strength indication than a coverage area wherein 56 bit encryption is being used. Similarly, a coverage area wherein watermarking is implemented at lower layers (i.e. physical or RF layer) may have a higher security strength indication than a coverage area wherein watermarking is implemented at higher layers (i.e. application layer).

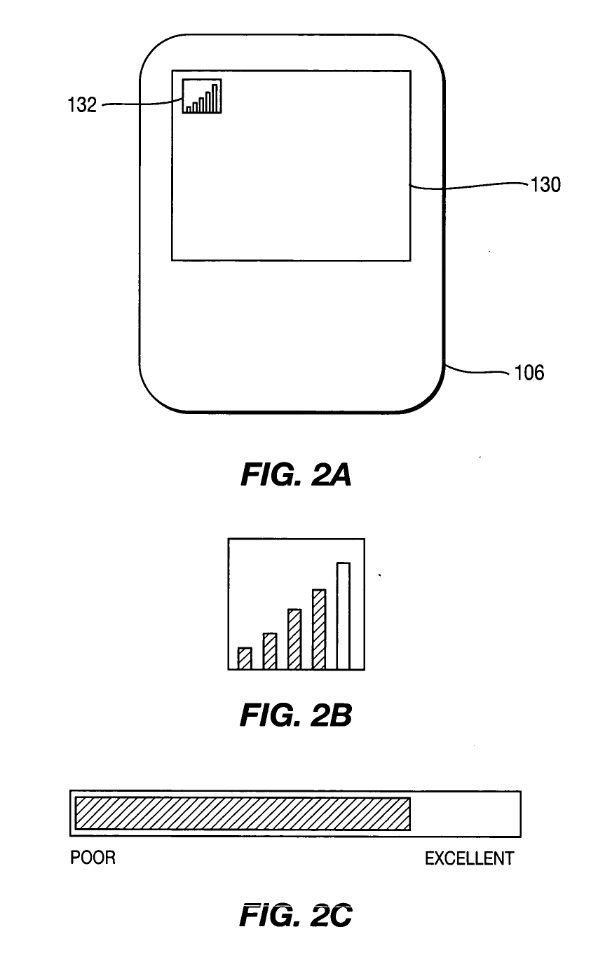

The security strength indicator may be displayed on a WTRU 106 in any manner as desired. For example, reference is now made to FIGS. 2A, 2B, and 2C. In FIG. 2A, a WTRU 106 having a screen 130 wherein a security strength indicator 132 is displayed. The security strength indicator can be anything sufficient to indicate a particular value among a range of values, e.g., a number in a range from a low number to a high number, such as the number 4 on a scale of 1 to 5 (not shown) or some type of graphic indicator. Or, color indicators can be used, for example, where green indicates good and tight security and red indicates loose or lax security, and yellow indicates an intermediate level of security. In such a scheme, white may represent an unknown, undetermined or unreported level of security. FIG. 2B is a first example of a graphical indicator indicating the equivalent of a security strength indicator value of four (4) wherein the indicator has a scale of one (1) to five (5), for example. FIG. 2C is a second example of a graphical indicator, also showing the equivalent of a security strength indicator value of four (4) on a scale of one (1) to five (5). Level zero (0) can represent an unknown, undetermined or unreported level of security.

### Location Tracking Using Watermarks

By way of explanation, a watermark is the insertion of metadata or other unique information into data transmitted between a transmitter and receiver for signaling and/or security purposes. Detailed descriptions of various watermarking techniques are provided in the '493, '174, and '987 applications referenced above.

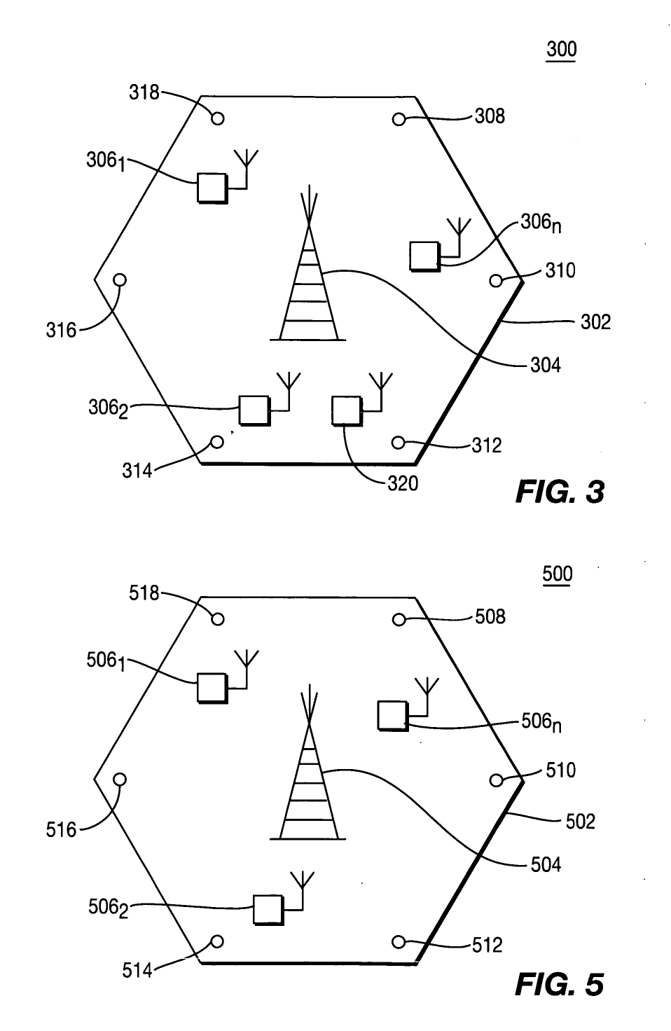

Referring now to FIG. 3, a coverage area 302 of a base station 304 of a wireless communication system 300 in accordance with the present invention is shown. The system includes a plurality of WTRUs 306₁, 306₂, and 306ₙ operating within the coverage area 302. Additionally, a plurality of sensors 308, 310, 312, 314, 316, 318 are deployed throughout the coverage area 302. The sensors 308, 310, 312, 314, 316, 318 are preferably configured to transmit at a relatively low power so that the RF range of the sensors is appropriate in view of the number of sensors that are deployed in an area and the relative spacing between them.

The sensors 308, 310, 312, 314, 316, 318 are configured to periodically (or in response to a specific command) transmit an identifier to WTRUs within its RF range which is forwarded by the WTRUs as an embedded watermark to their respective base station for purposes of tracking the location of the WTRUs. In a preferred embodiment, the network is aware of the location of each sensor 308, 310, 312, 314, 316, 318 and the particular identifier that each sensor 308, 310, 312, 314, 316, 318 transmits. Therefore, based on the watermark that is received and the WTRU from which the watermark was received, the location of the WTRU may be computed.

In one embodiment, WTRUs 306₁, 306₂, and 306ₙ authorized to operate within a coverage area 302 may simply be required to forward signals received from the sensors 308, 310, 312, 314, 316, 318 to the base station 304 as embedded watermarks. In this embodiment, the WTRUs 306₁, 306₂, and 306ₙ may not even be aware of the watermarks and are simply operating as a conduit for transmission of the identifiers from the sensors 308, 310, 312, 314, 316, 318 to the base station 304.

In another embodiment, however, the identifiers sent by the sensors may be encrypted, and the WTRUs 306₁, 306₂, and 306ₙ authorized to operate within a coverage area 302 may be provided with a key for extracting the identifiers. In this embodiment, WTRUs 306₁, 306₂, and 306ₙ authorized to operate within the coverage area 302 are provided with sufficient information to compute their location based on receipt of identifiers from the sensors 308, 310, 312, 314, 316, 318. In this embodiment, any WTRU, say WTRU 320, who fails to provide its location information upon request may be an unauthorized WTRU attempting to operate in a restricted/controlled area. Alternatively, WTRU 320 may be an authorized user that simply needs to be re-authenticated or a new user that needs to be authenticated.

### Transmission Of Non-Security Information Using Watermarks

Continuing to refer to FIG. 3, there are no restrictions to the type of information transmitted by sensors 308, 310, 312, 314, 316, 318 in the form of watermarks within a coverage area such as coverage area 302. For example, in large social gatherings such as a tradeshow, for example, it would be beneficial for the tradeshow participants having common professional interests to be made aware of each other's identity in order to maximize the probability of having mutually beneficial face-to-face discussions where desired. For example, in this embodiment, assume WTRUs 306₁, 306₂, and 306ₙ are registered participants of a trade show. As part of the registration process, participants are requested to provide information regarding themselves such as the industry in which they work and perhaps other relevant information. This information is broadcast as a watermark that can be received and displayed on the WTRUs 306₁, 306₂, and 306ₙ of all registered participants.

Therefore, in this embodiment, assume the user of WTRU 306₁ reviews the information provided voluntarily by other tradeshow participants and notices that the user of WTRU 306₂ is someone with whom the user of WTRU 306₁ would like to meet. In this example, the users of WTRUs 306₁ and 306₂ have a much higher probability of having a mutually productive meeting than if they were arbitrarily looking for people having similar professional interests. Of course, this embodiment may be implemented in any type of large gathering, professional or personal.

In another embodiment of the present invention, WTRUs 306₁, 306₂, and 306ₙ authorized to operate within a coverage area 302 may receive traffic, weather, news, or any other type of information as a watermark broadcast throughout the coverage area 302 by either the base station 304 or the sensors 308, 310, 312, 314, 316, 318. The WTRUs 306₁, 306₂, and 306ₙ themselves may also transmit such information as watermarks in an ad-hoc fashion.

In another embodiment of the present invention, more than one type of message can be simultaneously transmitted within data packets in a communication session. This can be accomplished by designating the primary communication signal the cover signal, and designating other types of messages auxiliary data that is embedded in the cover signal. For example, in a wireless telephone conversation, the transmitted and received voice signals can be designated cover signals. Short message service (SMS) messages can be sent simultaneously to or from the WTRU by embedding the messages as watermarks in the voice cover signals. It is noted, of course, that the primary communication signal and auxiliary data are not limited to being a voice signals and SMS messages, but may each be any type of signals. For example, the primary communication signal may be data packets transmitted during a web browsing session. Additionally, it is important to note that this embodiment may be implemented in both the uplink and downlink.

### Management of Watermarks

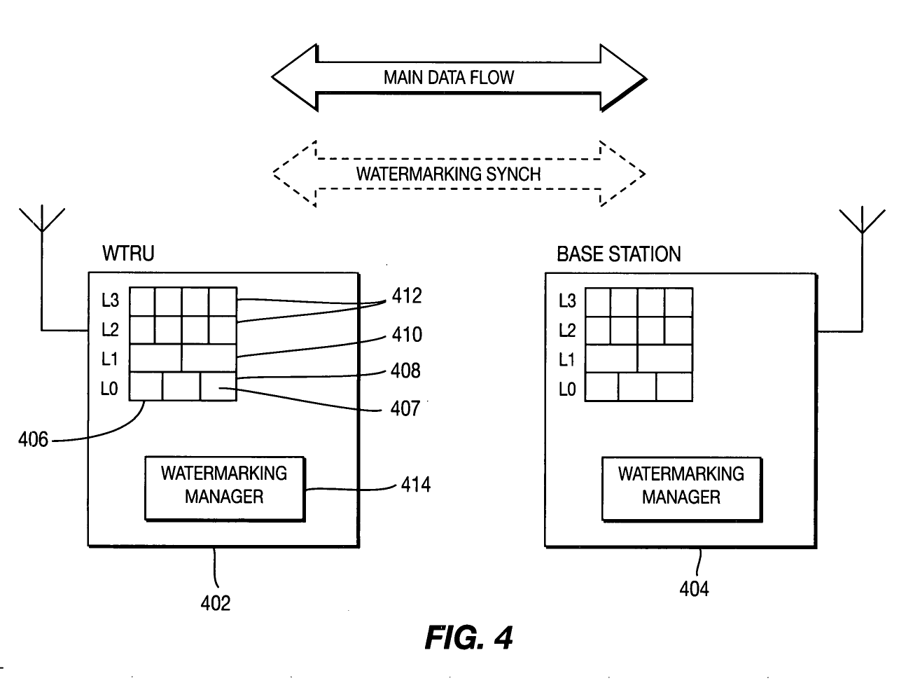

Referring now to FIG. 4, there is shown a WTRU 402 and base station 404 configured for managing the use of watermarks. For convenience, only the features of the WTRU 402 are described below as the WTRU 402 and base station 404 are identically configured with respect to management of watermarks. The WTRU 402 includes a watermarking stack 406 wherein at least one watermarking technique 407 is available at, for example, the RF layer (i.e. layer zero) 408, the physical layer (i.e. layer one) 410, and layer 2/3 412. The WTRU 402 also includes a watermarking manager 414. The watermarking manager 414 is configured to evaluate the state of the system including the application being run, intrusion detection status (i.e. have any intruders been recently detected, social group definition (i.e. is WTRU 402 currently being used at a tradeshow type setting as described above), etc. Based on this evaluation, the watermarking manager 414 selects an appropriate watermarking technique/layer or sets of watermarking techniques/layers.

To coordinate communications between two communicating entities, the watermarking manager 414 may transmit watermarking synchronization information. The watermarking synchronization information may be transmitted separate from a main data flow or as a watermark within the main data flow.

### Use Of Watermarks For Intrusion Detection

Referring now to FIG. 5, watermarks may be used for intrusion detection. In FIG. 5, a base station 504 of a wireless communication system 500 is shown. Operating within a coverage area 502 of the base station 504 are a plurality of WTRUs 506₁, 506₂, and 506ₙ. Additionally, a plurality of sensors 508, 510, 512, 514, 516, 518 are deployed at predetermined locations.

In this embodiment, the WTRUs 506₁, 506₂, and 506ₙ are required to insert a particular watermark in their transmissions which are monitored by the sensors 508, 510, 512, 514, 516, 518. Where a transmission is detected without the proper watermark, the WTRU from which the non-watermarked transmission was transmitted is flagged as an intruder. It is noted that the watermark may be varied on a periodic basis as an additional security measure.

In response to detection of an intruder, the base station 504 may take any number of actions. For example, the base station 504 may require that all WTRUs operating within a predetermined distance from the sensor that detected the non-watermarked transmission be re-authenticated. Alternatively, or in combination with re-authentication, the base station 504 may upgrade a security strength indicator for its coverage area 502. Another option is to broadcast the identity of the intruder to all of the WTRUs 506₁, 506₂, and 506ₙ with instructions to ignore the intruder's requests for the medium. In an 802.11 network, for example, this can be accomplished by ignoring any virtual carrier sense reports from the rogue transmitter. As mentioned above, this is less complicated than ignoring the physical carrier sense, since in that case the determination of the source is made at a higher layer. A watermark broadcasting the currently identified threat can also indicate which network mechanisms should be protected better.

In the event of a denial of service attack, all network devices can be instructed via watermarks to begin packet-by-packet inspection for a specific TA in the packet headers of network messages and problem packets may be ignored.

### Watermarking Applications

Watermarks are preferably used for the authentication, encryption, integrity, and auditing of data. Of course, watermarks may also be used for providing other types of protection in a communication system. To authenticate, a watermark is preferably inserted into a data transmission to authenticate the transmission as being genuine. With respect to encryption, a preferred embodiment of the invention is to include an encrypted version of a key as a watermark inserted into a set of encrypted data. With respect to integrity, conventional hashing functions append an authentication code onto the end of data being transmitted to a receiver. In the present invention, the authentication code is embedded as a watermark. With respect to auditing, in the telecommunications context, auditing can refer to being able to trace the path traversed by a data packet. Such an auditing function can be implemented using watermarking techniques as follows: Suppose that a data packet is sent from A to B via a number of intermediate nodes, referred to as N₁, N₂, . . . N_{M}. Each of the intermediate nodes has an associated unique signature (or identifier). As the packet traverses each of these nodes, the node inserts its own identifier as a watermark in the data packet and forwards it to the next node. At the end of the journey, the received data packet has a set of watermarks, which can be analyzed for auditing the communication path. Such an audit process can also be extended to the case where the intermediate nodes are general TRUs. Furthermore, the auditing process may also be used before the data packet reaches the ultimate recipient B.

Although the features and elements of the present invention are described in the preferred embodiments in particular combinations, each feature or element can be used alone (without the other features and elements of the preferred embodiments) or in various combinations with or without other features and elements of the present invention.

1. In a wireless communication system including a plurality of communicating entities, a method for securing a communication comprising:
transmitting a security strength indicator indicating the level of protection which is currently available in the communication system based on the applications being implemented in the communicating entities; and
adjusting communication parameters for the communication between the communicating entities in accordance with the security strength indicator.

2. The method of claim 1 wherein the security strength indicator is incorporated in the communication as a watermark.

3. The method of claim 1 wherein the communication system comprises a base station for servicing a wireless transmit/receive unit (WTRU) in a coverage area of the base station and the security strength indicator is generated on a per base station basis.

4. The method of claim 3 wherein the security strength indicator is broadcast by the base station.

5. The method of claim 3 wherein the security strength indicator is generated by either a radio network controller or the base station.

6. The method of claim 1 wherein the communication system is an ad-hoc network and the security strength indicator is generated by each communicating entity.

7. The method of claim 1 wherein the security strength indicator is computed at predetermined intervals.

8. The method of claim 1 wherein the security strength indicator is upgraded when an intruder is detected.

9. The method of claim 1 wherein the security strength indicator is quantified to indicate the level of the security strength.

10. The method of claim 9 wherein the security strength indicator is displayed on a display of the communicating entity.

11. In a wireless communication system including a plurality of sensors deployed throughout the coverage area of the wireless communication system, a base station and a wireless transmit/receive unit (WTRU), a method for locating the WTRU comprising:
transmitting an identifier from the sensors;
receiving the communication at the WTRU;
transmitting the identifier as an embedded watermark; and
determining the location of the WTRU utilizing the watermark and a known location of the sensors.

12. The method of claim 11 wherein the received communication is forwarded to the base station, and the base station determines the location of the WTRU after detecting the incorporated watermark.

13. The method of claim 11 wherein the identifier is encrypted and the WTRU is provided with a key for decoding the encrypted identifier and determines its after decoding the identifier.

14. The method of claim 13 wherein an unauthorized WTRU is detected when the WTRU fails to report its location upon request from the base station.

15. In a wireless communication system including a plurality of communicating entities, a method for utilizing a watermark comprising:
incorporating a watermark in a communication from a communicating entity, the watermark carrying information;
receiving the communication and detecting the watermark; and
retrieving the information from the detected watermark.

16. The method of claim 15 wherein the information is related to identity of the communicating entity.

17. The method of claim 15 wherein the communicating entities are a base station and a wireless transmit/receive unit (WTRU) served by the base station, and the base station broadcasts a watermark which carries information related to the coverage area of the base station.

18. The method of claim 15 wherein the wireless communication system is an ad-hoc network.

19. In a wireless communication system including a plurality of communicating entities, a method for utilizing a watermark comprising:
transmitting a communication incorporating a watermark by each communicating entity; and
detecting an unauthorized communicating entity by detecting the watermark in the communication.

20. The method of claim 19 wherein the watermark to be incorporated in the communication is varied periodically.

21. The method of claim 19 wherein at least the unauthorized communicating entity is required to be re-authenticated upon detection of the unauthorized communicating entity.

22. The method of claim 19 wherein a security measure is upgraded upon detection of the unauthorized communicating entity.

23. The method of claim 19 wherein an identity of the unauthorized communicating entity is broadcast upon detection of the unauthorized communicating entity, whereby communications from the unauthorized communicating entity are ignored by other communicating entities.

24. The method of claim 23 wherein all communicating entities are instructed to begin packet-by-packet inspection.

25. The method of claim 19 wherein an encrypted key is included as a watermark.

26. A wireless communication system comprising at least two communicating entities, each communicating entity comprising:
means for transmitting a security strength indicator indicating the level of protection which is currently available in the communication system based on the applications being implemented in the communicating entities; and
means for adjusting communication parameters for the communication between the communicating entities in accordance with the security strength indicator.

27. The system of claim 26 wherein the security strength indicator is incorporated in the communication as a watermark.

28. The system of claim 26 wherein the communication system comprises a base station for servicing a wireless transmit/receive unit (WTRU) in a coverage area of the base station and the security strength indicator is generated per base station basis.

29. The system of claim 28 wherein the security strength indicator is broadcast by the base station.

30. The system of claim 28 wherein the security strength indicator is generated by either a radio network controller or the base station.

31. The system of claim 26 wherein the communication system is an ad-hoc system and the security strength indicator is generated by each communicating entity.

32. The system of claim 26 wherein the security strength indicator is computed at predetermined intervals.

33. The system of claim 26 wherein the security strength indicator is upgraded when an intruder is detected.

34. The system of claim 26 wherein the security strength indicator is quantified to indicate the level of the security strength.

35. The system of claim 26 wherein the security strength indicator is displayed on a display of the communicating entity.

36. A wireless communication system for locating a wireless transmit/receive unit (WTRU) communicating within the system comprising:
a plurality of sensors deployed throughout the coverage area of the system, each sensor transmitting a communication incorporating a watermark;
a WTRU receiving the communication; and
means for determining the location of the WTRU utilizing the communication and the known location of the sensors.

37. The system of claim 36 wherein the received communication is forwarded to the base station as an embedded watermark, whereby the base station determines the location of the WTRU after detecting the watermark.

38. The system of claim 36 wherein the communication is encrypted and the means for determining the location of the WTRU is included in the WTRU and the WTRU is provided with a key for decoding the encrypted communication and is configured to determine its location based on the decoded communication.

39. The system of claim 38 wherein an unauthorized WTRU is detected when the WTRU fails to report its location upon request from the base station.

40. A wireless communication system for utilizing a watermark comprising:
a plurality of communicating entities, each communicating entity comprising:
means for incorporating a watermark in a communication from a communicating entity, the watermark carrying information;
means for receiving the communication and detecting the watermark; and
means for retrieving the information from the detected watermark.

41. The system of claim 40 wherein the information is related to identity of the communicating entity.

42. The system of claim 40 wherein the communicating entities are a base station and a wireless transmit/receive unit (WTRU) served by the base station, and the base station broadcasts a watermark which carries information related to the coverage area of the base station.

43. The system of claim 40 wherein the wireless communication system is an ad-hoc network.

44. A wireless communication system for utilizing a watermark comprising:
a plurality of communicating entities, each communicating entity comprising:
means for transmitting a communication incorporating a watermark; and
means for detecting an unauthorized communicating entity by detecting the watermark in the communication.

45. The system of claim 44 wherein the watermark to be incorporated in the communication is varied on a periodic basis.

46. The system of claim 44 wherein at least the unauthorized communicating entity is required to be re-authenticated upon detection of the unauthorized communicating entity.

47. The system of claim 44 wherein a security measure is upgraded upon detection of the unauthorized communicating entity.

48. The system of claim 45 wherein an identity of the unauthorized communicating entity is broadcast upon detection of the unauthorized communicating entity, whereby communications from the unauthorized communicating entity is ignored by other communicating entities.

49. The system of claim 48 wherein all communicating entities are instructed to begin packet-by-packet inspection.

50. The system of claim 45 wherein an encrypted key is included as a watermark.

51. In a wireless communication system including a plurality of communicating entities and a communication between the communicating entities is transmitted via at least one intermediate node, a method for utilizing a watermark comprising:
transmitting a communication from a first communicating entity to a second communicating entity via an intermediate node; and
incorporating unique signature into the communication by the intermediate node, whereby a transmission path of the communication is traced by the incorporated signature.

52. The method of claim 51 wherein the intermediate node is a general transmit/receive unit (TRU).

53. The method of claim 51 wherein the signature is incorporated as a watermark.

54. The method of claim 51 wherein the transmission path is traced before the communication is reached to the second communicating entity.

55. A wireless communication system for utilizing a watermark comprising:
a first communicating entity transmitting a communication;
a second communicating entity receiving the communication;
at least one intermediate node for transmitting the communication between the first communicating entity and the second communicating entity, and each intermediate node comprising a means for incorporating a unique signature into the communication, whereby a transmission path of the communication is traced by the incorporated signature.

56. The system of claim 55 wherein the intermediate node is a general transmit/receive unit (TRU).

57. The system of claim 55 wherein the signature is incorporated as a watermark.

58. The system of claim 55 wherein the transmission path is traced before the communication is reached to the second communicating entity.

59. An integrated circuit (IC) comprising:
a transmitter configured to transmit a security strength indicator indicating the level of protection which is currently available in a communication system based on applications being implemented in communicating entities operating within the communication system; and
a watermarking manager configured to adjust communication parameters for communications between the communicating entities in accordance with the security strength indicator.
